(19) United States
(12) Patent Application Publication
(10) Pub. No.: US 2021/0208099 A1
(43) Pub. Date: Jul. 8, 2021

(54) POTENTIOMETRIC MEASURING CHAIN AND METHOD FOR DETERMINING THE PH VALUE

(71) Applicant: SIEMENS AKTIENGESELLSCHAFT, München (DE)

(72) Inventors: Günter Fafilek, Bisamberg (AT); Martin Joksch, St.Andrä-Wördern (AT); Stefan Wibihal, Wien (AT); Johannes Österreicher, Perchtoldsdorf (AT)

(21) Appl. No.: 17/057,584

(22) PCT Filed: May 27, 2019
(86) PCT No.: PCT/EP2019/063651

§ 371 Date: Nov. 20, 2020

(30) Foreign Application Priority Data
May 29, 2018 (DE) 10 2018 208 482.3

(51) Int. Cl. G01N 27/416; G01N 27/48; G01N 27/27

(52) U.S. Cl. CPC G01N 27/4165; G01N 27/27; G01N 27/48; G01N 27/4167

(57) ABSTRACT

Disclosed is a potentiometric rod-shaped measuring chain for determining the pH value, comprising a measuring half-cell with a measuring electrode (1) and a reference half-cell with at least one reference electrode (2). In order to be able to carry out a functional check of the measuring chain during the pH measurement, provision is made for a voltammetric measuring cell with a working electrode (4) and a counterelectrode (5) to be additionally provided for the purpose of checking the potential measurement of the measuring chain, wherein the voltammettic measuring cell is connected to a voltammetric evaluation unit.

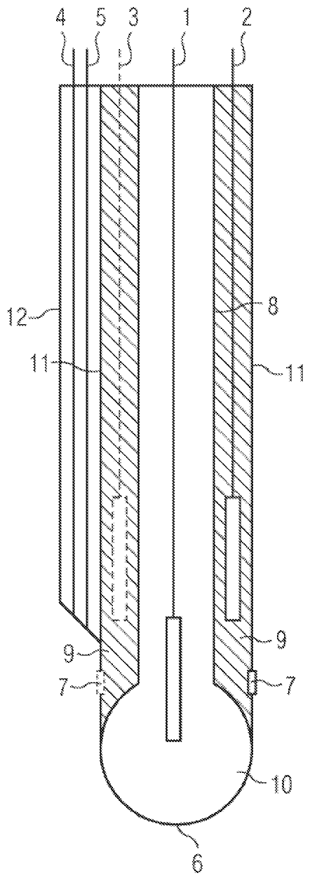

### FIELD OF THE INVENTION

The invention relates to a potentiometric rod-shaped measuring chain for determining the pH value, comprising a measuring half-cell and a reference half-cell, and a corresponding method. The invention is used to measure the pH of solutions using potentiometric cells.

### PRIOR ART

Such measuring chains, in particular pH single-rod measuring chains, are described, for example, in DIN 19261:2016. A measuring chain in the form of a single-rod measuring chain is also known from DE 10 2015 118 581 A1, for example.

The combination of working electrode, hereinafter also referred to as a measuring electrode, and reference electrode in one unit is called a single-rod measuring chain.

A typical potentiometric measuring chain is designed as a pH glass electrode, which allows a particularly simple determination of pH values in solutions. This single-rod measuring chain is made up of an inner tube and an outer jacket. The outer jacket delimits the reference half-cell and contains the reference electrode (usually a silver-silver chloride electrode). The reference electrode usually comprises a silver wire, silver chloride, and is surrounded by an electrolyte solution (usually potassium chloride). Silver wire, silver chloride, and potassium chloride solution, which also contains a buffer (e.g. phosphate buffer), are also disposed in the inner tube that delimits the measuring half-cell. The inner tube is connected to the solution to be measured with a glass membrane, the outer jacket with a diaphragm.

The potential of the measuring electrode occurs as follows: Via a diaphragm (e.g. platinum sponge or porous ceramic), the reference electrode arranged in the reference half-cell is in electrical contact with the solution to be measured, wherein the diaphragm, however, largely prevents material exchange with the solution in order not to change the potential of the reference electrode by foreign ions. The diaphragm is saturated with potassium chloride solution, which also forms the internal electrolyte of the measuring chain. Potassium chloride is the only electrolyte that has the property that its cations (K+) and anions (Cl−) have practically the same ion mobility. Therefore, with these electrolytes no additional potentials develop on the diaphragm, which could falsify the measurement.

The measuring electrode is disposed in the measuring half-cell in a buffered potassium chloride solution adjusted to pH 7. Through a very thin glass membrane(≈50 μm), the measuring electrode is in conductive connection with the solution to be measured, on which solution the potential used for pH measurement is created. The sodium and lithium ions in the glass membrane can move relatively freely, but the glass membrane is impermeable to hydrogen ions. Nevertheless, the hydrogen ions can occupy lattice sites on the oxygen anions of the supercooled silicate melt of the glass, since this melt begins to swell on the surface on contact with the aqueous solution. A low pH value means that the hydrogen ions populate the lattice sites and the sodium and lithium ions “push back” into the glass membrane. Since these can move freely in the glass membrane, they tend to be shifted to the inside of the glass membrane, creating the measured potential difference. At a high pH value, the hydrogen ion concentration in the interior of the measuring half-cell predominates, the process described goes in a different direction, the potential is created with a different sign.

The rod-shaped measuring chain for determining the pH value must be recalibrated at regular intervals, e.g. daily. Determining a drift and functional checking during the measurement is not possible with conventional methods of the pH value.

Various methods are already known for checking the measurement result of the measurement chain and for calibrating the latter. For example, U.S. Pat. No. 5,766,432 A provides a plurality of reference electrodes for measuring the pH value that are intended to help eliminate a drift over time in that the mean value over several reference electrodes is found. This method is not very accurate. According to EP 1 143 239 A1, the frequency response of the sensor impedance is measured over a certain frequency range in order to monitor electrochemical measuring sensors which have at least one measuring electrode, but this is complex.

### DISCLOSURE OF THE INVENTION

It is therefore an object of the invention to provide a potentiometric rod-shaped measuring chain for determining the pH value which overcomes the disadvantages of the prior art and in particular allows a drift to be determined or a functional check to be carried out during the pH measurement. This can improve the reliability of long-term measurements in particular.

This object is inventively achieved by claim 1. The starting point is a potentiometric rod-shaped measuring chain for determining the pH value and comprising a measuring half-cell and a reference half-cell. To check the potential measurement of the measuring chain, a voltammetric measuring cell with a working electrode and a counterelectrode is also provided, wherein the voltammetric measuring cell is connected to a voltammetric evaluation unit.

The term voltammetry (volt-amperometry) is understood to mean the recording of current-voltage curves with stationary or fixed working electrodes. The current strength is measured as the voltage changes over time. In voltammetry, a voltage is applied to an electrochemical cell to cause a Faraday reaction and the resulting current, usually limited by diffusion, is measured. The relationship between measured size and concentration results directly from the linear influence of the concentration on the diffusion rate. In voltammetry, the applied voltage is changed and a current/voltage graph (voltammogram) is recorded.

Thus, according to the invention, a known pH measuring chain is supplemented with a voltammetric unit comprising a voltammetric measuring cell and a voltammetric evaluation unit. The voltammetric unit uses current-voltage curves to check the pH measurement of the single-rod measuring chain, more precisely the measuring electrode. The voltammetric measuring cell is preferably permanently connected to the rest of the pH measuring chain and forms a mechanical unit therewith. The voltammetric evaluation unit can be integrated into the evaluation unit of the measuring chain.

While the measuring half-cell and the reference half-cell are generally designed to be essentially rotationally symmetrical about the longitudinal axis of the rod-shaped measuring chain, the voltammetric measuring cell preferably does not extend about the entire circumference of the measuring chain. The working electrode and the counterelectrode of the voltammetric measuring cell are, for example, small disks; the working electrode often has a diameter of only 50-100 μm. Both electrodes can therefore be attached to the side of the actual pH sensor.

An additional reference electrode can be provided for the voltammetric measuring cell. In this way, the potential of the voltammetric measurement can be defined with respect to this additional reference electrode.

The additional reference electrode for the voltammetric measuring cell can advantageously be arranged in the reference half-cell. There is therefore no need to provide a separate section for the additional reference electrode in the measuring chain; rather, the existing reference half-cell can be used.

A second possibility for determining the potential of the voltammetric measuring cell is for the voltammetric measuring cell to be connected to the reference electrode of the reference half-cell such that the potential of the voltammetric measuring cell can be measured against the reference electrode of the reference half-cell. There is no need to provide an additional reference electrode.

A third possibility for determining the potential of the voltammetric measuring cell is for the voltammetric measuring cell to be connected to the measuring electrode of the measuring half-cell such that the potential of the voltammetric measuring cell can be measured against the measuring electrode of the measuring half-cell. Again, it is not necessary to provide an additional reference electrode.

It is generally advantageous if the voltammetric measuring cell lies outside, in particular radially outside, the measuring half-cell with respect to the longitudinal axis of the rod-shaped measuring chain. This means that it is not necessary to change the structure of the measuring chain.

If the voltammetric measuring cell lies outside, in particular radially outside, the reference half-cell with respect to the longitudinal axis of the rod-shaped measuring chain, an existing measuring chain can easily be supplemented with the voltammetric measuring cell.

In particular, it can be provided in this regard that the longitudinal axis of the rod-shaped measuring chain is defined by the measuring half-cell, the reference half-cell surrounds the measuring half-cell, and the voltammetric measuring cell surrounds the reference half-cell or is positioned on the side of the reference half-cell, in particular is positioned on the side of the reference half-cell, wherein in each of these cases the measuring half-cell, reference half-cell, and voltammetric measuring cell form a mechanical unit.

The method for determining the pH value using an inventive potentiometric rod-shaped measuring chain provides that during the pH value determination by means of the measuring electrode of the measuring half-cell and the reference electrode of the reference half-cell, a voltammetric measurement is carried out using the working electrode and the counterelectrode of the voltammetric measuring cell. For the voltammetric measurement, the voltammetric measuring cell is in electrical connection with a voltammetric evaluation unit, which records and evaluates the current-voltage curves.

If the evaluation of the current-voltage curves yields a deviation, the measured values of the measuring half-cell are corrected based on the measurement result of the voltammetric measuring cell.

Depending on whether or not an additional reference electrode is provided for the voltammetric measuring cell, the potential of the voltammetric measuring cell can be measured against the reference electrode of the reference half-cell, or against the measuring electrode of the measuring half-cell, or against an additional reference electrode, the latter possibly being arranged in the reference half-cell, in addition to the reference electrode of the reference half-cell.

If an additional reference electrode is provided, the reference electrode of the reference half-cell can be checked with the additional reference electrode.

### BRIEF DESCRIPTION OF THE FIGURES

To further explain the invention, reference is made in the following part of the description to the schematic FIGURE, from which further advantageous details and possible areas of application of the invention can be taken. The FIGURE is to be understood as exemplary and is intended to illustrate the character of the invention, but in no way restrict it or reproduce it conclusively. The FIGURE illustrates a longitudinal section through an inventive arrangement.

### WAYS OF CARRYING OUT THE INVENTION

The FIGURE illustrates an inventive measuring chain for determining pH. The measuring chain is rod-shaped and comprises a measuring half-cell and a reference half-cell. The measuring chain has a longitudinal axis which here coincides with the measuring electrode 1, which is also referred to as the pH electrode. The measuring half-cell contains the measuring electrode 1 and the inner buffer 10 in the form of a solution. The measuring half-cell is delimited by the wall 8, specifically with respect to the reference half-cell and the space that surrounds the measuring chain. The reference half-cell is preferably arranged coaxially with the measuring half-cell and is delimited by a wall 11 to the environment, and to the measuring half-cell by the wall 8, along which the reference electrode 2 extends, at least in some regions. Each of the two half-cells has a chamber, the reference half-cell having an outer chamber of the measuring chain and the measuring half-cell having an inner chamber of the measuring chain. In addition to the reference electrode 2, the reference half-cell has a reference electrolyte 9 and sometimes fillers (e.g., graphite).

The measuring half-cell has a glass membrane 6 in contact with the medium and arranged at the end of the measuring chain. A measuring circuit is arranged at the opposing end of the measuring chain as part of an evaluation device, which is not shown here. This end is otherwise closed in a liquid-tight manner. The reference half-cell has a liquid transition in the form of a diaphragm 7.

The voltammetric measuring cell is arranged on the outside of the reference half-cell, the wall 12 of the voltammetric measuring cell adjoining the wall 11 of the reference half-cell. The voltammetric measuring cell essentially comprises a working electrode 4 and a counterelectrode 5. The working electrode 4 is embodied, for example, as a microelectrode, which ideally has a diameter in a range from 50 to 100 μm. Furthermore, the working electrode 4 and the counterelectrode 5 are each embedded in an insulating material. For example, glass or a glass tube in which the respective electrodes 4, 5 are embedded or melted and only the lower end of which extends into the analyte can be used as the insulating material. The electrolyte of the measuring chain is the analyte that is to be measured, and the lower end of the electrodes 4, 5 reach into the analyte.

Either an additional reference electrode 3, which is arranged here in the reference half-cell, can be provided as the reference electrode for the voltammetric measurement, or the measuring electrode 1 or the reference electrode 2 can be used for this purpose.

The voltammetric measuring cell extends far enough towards the glass membrane 6 that the diaphragm 7 of the reference half-cell is not covered. At the other end of the measuring chain, the voltammetric measuring cell is flush with the two half-cells.

### LIST OF REFERENCE SYMBOLS

1 Measuring electrode (pH electrode)

2 Reference electrode

3 Additional reference electrode

4 Working electrode of the voltammetric measuring cell

5 Counter electrode of the voltammetric measuring cell

6 Glass membrane (pH membrane)

7 Diaphragm

8 Wall of the measuring half-cell

9 Reference electrolyte

10 Inner buffer

11 Wall of the reference half-cell

12 Wall of the voltammetric measuring cell

1-15. (canceled)

16. A potentiometric rod-shaped measuring chain for determiningp1-1 value comprising:
a measuring half-cell with a measuring electrode; and
a reference half-cell with at least one reference electrode;
wherein a voltammetric measuring cell having a working electrode and a counterelectrode is provided for checking a potential measurement of the measuring chain, wherein the voltammetric measuring cell is connected in use to a voltammetric evaluation uni t,

17. The measuring chain of claim 16, wherein an additional reference electrode is provided for the voltammetric measuring cell.

18. The measuring chain of claim 17, wherein the additional reference electrode for the voltammetric measuring cell is arranged in the reference half-cell.

19. The measuring chain of claim 16, wherein the voltammetric measuring cell is connected to the reference electrode of the reference half-cell such that the potential of the voltammetric measuring cell can be measured against the reference electrode of the reference half-cell.

20. The measuring chain of claim 16, wherein the voltammetric measuring cell is connected to the measuring electrode of the measuring half-cell such that the potential of the voltammetric measuring cell can be measured against the measuring electrode of the measuring half-cell.

21. The measuring chain of claim 16, wherein the voltammetric measuring cell lies outside the measuring half-cell with respect to a. longitudinal axis of the rod-shaped measuring chain.

22. The measuring chain of one of claim 16, wherein the voltammetric measuring cell lies outside the reference half-cell with respect to a longitudinal axis of the rod-shaped measuring chain.

23. The measuring chain of claim 21, wherein the longitudinal axis of the rod-shaped measuring chain is defined by the measuring half-cell, the reference half-cell surrounds the measuring half-cell, and the voltammetric measuring cell is positioned on a side of the reference half-cell, wherein the measuring half-cell, reference half-cell, and voltammetric measuring cell form a mechanical unit.

24. A method for pH value determination using a potentiometric rod-shaped measuring chain according to claim 16, wherein during the pH value determination by means of the measuring electrode of the measuring half-cell and the reference electrode of the reference half-cell, a voltammetric measurement is carried out using the working electrode and the counterelectrode of the voltammetric measuring cell.

25. The method of claim 24, wherein the measured values of the measuring half-cell are corrected based on the measurement result of the volammetric measuring cell.

26. The method of claim 24, wherein the potential of the voltammetric measuring cell is measured against the reference electrode of the reference half-cell.

27. The method of claim 24, wherein the potential of the voltammetric measuring cell is measured against the measuring electrode of the measuring half-cell.

28. The method of claim 24, wherein the potential of the voltammetric measuring cell is measured against an additional reference electrode.

29. The method of claim 28, wherein the potential of the voltammetric measuring cell is measured against an additional reference electrode which is arranged in the reference half-cell.

30. The method of claim 28, wherein the reference electrode of the reference half-cell is checked with the additional reference electrode.
